(19) United States
(12) Patent Application Publication
(10) Pub. No.: US 2024/0297321 A1
(43) Pub. Date: Sep. 5, 2024

(54) METHOD FOR PRODUCING AN ELECTROCHEMICAL CELL UNIT

(71) Applicant: Robert Bosch GmbH, Stuttgart (DE)

(72) Inventors: Andreas Ringk, Bamberg (DE); Anton Ringel, Bamberg (DE)

(21) Appl. No.: 18/570,241

(22) PCT Filed: Jun. 14, 2022
(86) PCT No.: PCT/EP2022/066071

§ 371 Date: Dec. 14, 2023

(30) Foreign Application Priority Data
Jun. 17, 2021 (DE) 10 2021 206 205.9

(51) Int. Cl. H01M 8/1004; C25B 9/63; C25B 9/75; C25B 9/77; H01M 8/2404; H01M 8/242

(52) U.S. Cl. CPC H01M 8/1004; C25B 9/63; C25B 9/75; C25B 9/77; H01M 8/2404; H01M 8/242

(57) ABSTRACT

A method for producing an electrochemical cell unit for converting electrochemical energy into electrical energy as fuel cell unit and/or for converting electrical energy into electrochemical energy as electrolysis cell unit comprising stacked electrochemical cells, the method comprising the following steps: making available layered components (6, 9, 10) of the electrochemical cells, namely preferably proton-exchange membranes, anodes, cathodes, preferably membrane electrode arrangements (6), preferably gas diffusion layers (9) and bipolar plates (10), stacking the layered components (6, 9, 10) to form electrochemical cells and to form a stack of the electrochemical cell unit, the bipolar plates (10) being made available such that at least one suction opening (71) is formed in each of the bipolar plates (10) and components (6, 9, 10) of the electrochemical cells are brought by suction by means of a reduced pressure in the suction openings (71) during production, such that the components (6, 9, 10) brought to the suction openings (71) by suction are fixed to the bipolar plates (10) by means of the reduced pressure.

### BACKGROUND

The present invention relates to a method of producing an electrochemical cell unit and an electrochemical cell unit.

Fuel cell units as galvanic cells convert continuously supplied fuel and oxidizing agent into electrical energy and water by means of redox reactions at an anode and cathode. Fuel cells are used in a wide variety of stationary and mobile applications, e.g., in houses without a connection to the electricity grid or in motor vehicles, rail transport, aviation, space travel, and shipping. In fuel cell units, a large number of fuel cells are arranged in a stack.

In fuel cell units, a large number of fuel cells are arranged in a fuel cell stack. Inside each fuel cell there is a gas chamber for oxidizing agents, i.e. a flow chamber for passing through oxidizing agents, such as air from the surroundings with oxygen. The gas chamber for oxidizing agents is formed by ducts on the bipolar plate and by a gas diffusion layer for a cathode. The channels are thereby formed by a corresponding channel structure of a bipolar plate and the oxidizing agent, i.e. oxygen, reaches the cathode of the fuel cells through the gas diffusion layer. Similarly, a gas chamber for fuel is provided.

Electrolysis cell units consisting of stacked electrolysis cells, similar to fuel cell units, are used for the electrolytic production of, e.g., hydrogen and oxygen from water. Furthermore, fuel cell units are known which can be operated as reversible fuel cell units and therefore as electrolysis cell units. Fuel cell units and electrolysis cell units form electrochemical cell units. Fuel cells and electrolysis cells form electrochemical cells.

In the production of a fuel cell unit, layered components of the fuel cells, i.e., proton exchange membranes, anodes, cathodes, gas diffusion layers and bipolar plates, are stacked to form a stack comprising fuel cells. The gas diffusion layers and/or membrane electrode arrays are placed on the bipolar plates based on the arrangement. The gas diffusion layers and/or membrane electrode assemblies have a low mass and a low specific weight. For this reason, the gas diffusion layers and/or membrane electrode arrangements can slip slightly after being placed on the bipolar plates, e.g. due to air currents, so that a relative movement occurs on the one hand between the gas diffusion layers and/or membrane electrode arrangements and on the other hand the bipolar plates in a direction parallel to imaginary planes spanned by the layered components. In other words, after the gas diffusion layers and/or membrane electrode arrays have been placed on the bipolar plates and before a further layered component is placed, an additional complex and correct alignment of the gas diffusion layers and/or membrane electrode arrays relative to the bipolar plates is necessary.

### SUMMARY

A method for producing an electrochemical cell unit for converting electrochemical energy into electrical energy as fuel cell unit and/or for converting electrical energy into electrochemical energy as electrolysis cell unit comprising stacked electrochemical cells, the method comprising the following steps: making available layered components of the electrochemical cells, namely preferably proton exchange membranes, anodes, cathodes, preferably membrane electrode arrangements, preferably gas diffusion layers and bipolar plates, stacking the layered components to form electrochemical cells and to form a stack of the electrochemical cell unit, the bipolar plates being made available such that at least one suction opening is formed in each of the bipolar plates and components of the electrochemical cells are brought by suction by means of a reduced pressure in the suction openings during production, such that the components brought to the suction openings by suction are fixed to the bipolar plates by means of the reduced pressure. In an advantageous manner, the reduced pressure in the suction openings causes and results in a compressive force between the contact surfaces of the bipolar plates and the contact surfaces of the components brought by suction so that the components brought by suction are fixed to the bipolar plates by means of frictional and/or positive connections between the bipolar plates and components. In an advantageous manner, relative movements between the bipolar plates and the components brought by suction can be excluded during production, thus ensuring exact positioning of the components brought by suction on the bipolar plates.

In an additional variant, the components brought by suction are placed on the bipolar plates and the reduced pressure is generated in the suction openings before and/or during and/or after placement.

In a further embodiment, the reduced pressure is generated by at least one vacuum pump.

In an additional embodiment, multiple suction openings are formed in each bipolar plate and preferably the suction openings are connected to each other in an air-conducting manner by an air channel integrated into each bipolar plate.

In an additional variant, the air channel opens into one, in particular only one, connecting opening on an outer side of the respective bipolar plate, so that the reduced pressure is generated at the suction openings, in particular all suction openings, of the respective bipolar plate by means of a reduced pressure at the one connecting opening. In an advantageous manner, a reduced pressure at the connection opening of one bipolar plate can be used to generate a reduced pressure or air suction at all suction openings of this bipolar plate.

In a further embodiment, components in the form of membrane electrode arrays of the electrochemical cells are brought by suction during production by means of a reduced pressure in the suction openings.

After the membrane electrode assemblies have been placed on the bipolar plates, the suction openings are advantageously arranged on subgaskets of the membrane electrode assemblies so that the subgaskets of the membrane electrode assemblies are brought by suction by means of the reduced pressure in the suction openings. The subgaskets have a low permeability to air, so that even a small reduced pressure is sufficient to reliably fix the subgasket and thereby also the membrane electrode arrangement to the bipolar plate.

In a further embodiment, gas diffusion layers are arranged between the bipolar plates and membrane electrode arrangements, this preferably being performed in succession for different bipolar plates, membrane electrode arrangements and gas diffusion layers. Preferably, a gas diffusion layer is arranged between each bipolar plate and each membrane electrode arrangement, whereby this is preferably performed for a bipolar plate, membrane electrode arrangement and gas diffusion layer.

In an additional embodiment, during the placement of the membrane electrode arrangements on the bipolar plates, the bipolar plates are oriented substantially horizontally and the membrane electrode arrangements are placed on the upper sides of first bipolar plates and brought by suction by means of the reduced pressure in the suction openings and/or the membrane electrode arrangements are placed on the lower sides of second bipolar plates and brought by suction by means of the reduced pressure in the suction openings. Essentially horizontally oriented means preferably that the bipolar plates are oriented at a deviation of less than 30°, 20°, 10°, or 5° to a horizontal plane.

Preferably, at least one bipolar plate comprising at least one component brought by suction forms an intermediate assembly unit. Intermediate assembly units therefore comprise one or multiple bipolar plates and one or multiple components.

In a further embodiment, the intermediate assembly units are produced outside an already partially stacked stack of stacked electrochemical cells and then the intermediate assembly units are placed on top of the already partially stacked stack of stacked electrochemical cells.

In an additional embodiment, the intermediate assembly units are moved using a robot to the already partially stacked stack comprising stacked electrochemical cells and placed on the already partially stacked stack.

In an additional variant, the components and/or intermediate assembly units are moved using mechanical grippers and/or suction pads on at least one robot by means of the at least one robot. Mechanical grippers are, e.g., designed to have two movable gripper arms, or as a frame structure for placing the at least one component and/or the at least one intermediate assembly unit.

In an additional embodiment, during the movement of the intermediate assembly units, the connecting openings of the bipolar plates are connected to a suction tube on the at least one robot in a fluidically conducting manner, so that the reduced pressure is generated in the suction openings of the bipolar plates by means of a reduced pressure in the suction tube.

Electrochemical cell unit according to the invention for converting electrochemical energy into electrical energy as a fuel cell unit and/or for converting electrical energy into electrochemical energy as an electrolysis cell unit, comprising stacked electrochemical cells and the electrochemical cells each comprising stacked layered components and the components of the electrochemical cells preferably being proton exchange membranes, anodes, cathodes, preferably membrane electrode arrangements, preferably gas diffusion layers and bipolar plates, the electrochemical cell unit being produced by a method described in the present patent application and/or suction openings being formed in the bipolar plates for the suction of components by means of a reduced pressure during production.

In an additional embodiment, the suction openings are designed as through-holes which connect the upper side of the bipolar plate to the underside of the bipolar plate in a fluidically conducting manner. Regarding the suction of a layered component on the upper side of the bipolar plate, it is thereby necessary to apply a reduced pressure to the through-holes of the bipolar plate that lead into the lower sides. For each suction opening formed by the mouth of the through-hole on the upper side, a reduced pressure must therefore be applied separately for each through-hole on the underside, e.g., by means of suction conduits on a frame construction as a gripper.

Preferably, the membrane electrode arrangements are each formed by a proton exchange membrane, at least one subgasket, one anode and one cathode, in particular as a CCM (catalyst coated membrane) with catalyst material in the anodes and cathodes.

Preferably, the membrane electrode arrangements are each formed by a proton exchange membrane, at least one subgasket, an anode and a cathode, as a CCM (catalyst coated membrane) with catalyst material in the anodes and cathodes and, in addition, two gas diffusion layers are attached to the membrane electrode arrangements, one to the anode and one to the cathode, preferably materially bonded, and preferably this membrane electrode arrangement comprising two gas diffusion layers is placed on a bipolar plate during production.

In a further variant, the electrochemical cell unit comprises at least 50, 100 or 200 stacked electrochemical cells.

In a further variant, the method described in the present patent application is used to produce an electrochemical cell unit described in the present patent application.

The invention further comprises a computer program comprising program code means stored on a computer-readable data carrier for performing a method described in this patent application when the computer program is executed on a computer or a corresponding computing unit.

The invention also relates to a computer program product comprising program code means stored on a computer-readable data carrier for performing a method described in the present patent application when the computer program is executed on a computer or a corresponding computing unit.

In an additional embodiment, the electrochemical cell unit is a fuel cell unit in the form of a fuel cell stack for converting electrochemical energy into electrical energy, and/or an electrolysis cell unit for converting electrical energy into electrochemical energy.

The bipolar plates are advantageously designed as separator plates and an electrical insulation layer, in particular a proton exchange membrane, is arranged between each anode and each cathode and preferably the electrolysis cells each comprise a third channel for the separate passage of a cooling fluid as a third process fluid.

In an additional variant, the electrolysis cell unit is additionally designed as a fuel cell unit, in particular a fuel cell unit described in this property right application, so that the electrolysis cell unit forms a reversible fuel cell unit.

In another variant, the first substance is oxygen and the second substance is hydrogen.

In another variant, the electrolysis cells of the electrolysis cell unit are fuel cells.

In a further variant, the electrochemical cell unit comprises a housing and/or a connection plate. The stack is enclosed by the housing and/or the connection plate.

A fuel cell system according to the invention, in particular for a motor vehicle, comprising a fuel cell unit as a fuel cell stack comprising fuel cells, a compressed gas reservoir for storing gaseous fuel, a gas conveying device for conveying a gaseous oxidizing agent to the cathodes of the fuel cells, the fuel cell unit being designed as a fuel cell unit and/or electrolysis cell unit described in the present patent application.

An electrolysis system and/or fuel cell system according to the invention, comprising an electrolysis cell unit as an electrolysis cell stack comprising electrolysis cells, preferably a compressed gas reservoir for storing gaseous fuel, preferably a gas conveying device for conveying a gaseous oxidizing agent to the cathodes of the fuel cells, a storage reservoir for liquid electrolyte, a pump for conveying the liquid electrolyte, whereby the electrolysis cell unit is designed as an electrolysis cell unit and/or fuel cell unit described in the present patent application.

In a further embodiment, the fuel cell unit described in this property right application additionally forms an electrolysis cell unit and preferably vice versa.

In a further variant, the electrochemical cell unit, in particular the fuel cell unit and/or the electrolysis cell unit, comprises at least one connecting device, in particular a plurality of connecting devices, and clamping elements.

Advantageously, components for electrochemical cells, in particular fuel cells and/or electrolysis cells, preferably include insulation layers, in particular proton exchange membranes, preferably membrane electrode arrangements, anodes, cathodes, preferably gas diffusion layers and bipolar plates, in particular separator plates.

In a further embodiment, the electrochemical cells, in particular fuel cells and/or electrolysis cells, each preferably comprise an insulating layer, in particular a proton exchange membrane, an anode, a cathode, preferably membrane electrode arrangements, preferably at least one gas diffusion layer and at least one bipolar plate, in particular at least one separator plate.

In a further embodiment, the connection device is designed as a bolt, and/or is rod-shaped, and/or is designed as a tensioning belt.

The tensioning elements are advantageously designed as clamping plates.

In a further variant, the gas conveying device is designed as a blower, and/or a compressor, and/or a pressure reservoir with an oxidizing agent.

In particular, the electrochemical cell unit, in particular fuel cell unit and/or electrolysis cell unit, comprises at least 3, 4, 5, or 6 connection devices.

In a further embodiment, the tensioning elements are plate-shaped and/or disc-shaped and/or planar and/or designed as a grid.

Preferably, the fuel is hydrogen, hydrogen-rich gas, reformate gas, or natural gas.

Advantageously, the fuel cells and/or electrolysis cells are essentially flat and/or disc-shaped.

In an additional variant, the oxidizer is air with oxygen or pure oxygen.

Preferably, the fuel cell unit is a PEM fuel cell unit comprising PEM fuel cells or an SOFC fuel cell unit comprising SOFC fuel cells or an alkaline fuel cell (AFC).

### BRIEF DESCRIPTION OF THE DRAWINGS

Exemplary embodiments of the invention are explained in greater detail hereinafter with reference to the accompanying drawings. Shown are:

FIG. 1 a highly simplified, exploded view of an electrochemical cell system as a fuel cell system and electrolysis cell system comprising components of an electrochemical cell as a fuel cell and electrolysis cell,

FIG. 2 a perspective view of part of a fuel cell and electrolysis cell,

FIG. 3 a longitudinal section through electrochemical cells as fuel cells and electrolysis cells,

FIG. 4 a perspective view of an electrochemical cell unit as a fuel cell unit and electrolysis cell unit as a fuel cell stack and electrolysis cell stack,

FIG. 5 a side view of the electrochemical cell unit as a fuel cell unit and electrolysis cell unit as a fuel cell stack and electrolysis cell stack,

FIG. 6 a perspective view of a bipolar plate,

FIG. 7 a perspective view of a membrane electrode arrangement,

FIG. 8 a side view of a robot,

FIG. 9 a perspective view of a first bipolar plate and a membrane electrode arrangement,

FIG. 10 a perspective view of the first bipolar plate comprising the placed membrane electrode arrangement comprising gas diffusion layers as an intermediate assembly unit and a second bipolar plate and before the second bipolar plate is applied to the intermediate assembly unit, and

FIG. 11 a perspective view of a first bipolar plate, a membrane electrode arrangement comprising gas diffusion layers and a second bipolar plate before the membrane electrode arrangement comprising gas diffusion layers is placed on and sucked onto an underside of the second bipolar plate.

### DETAILED DESCRIPTION

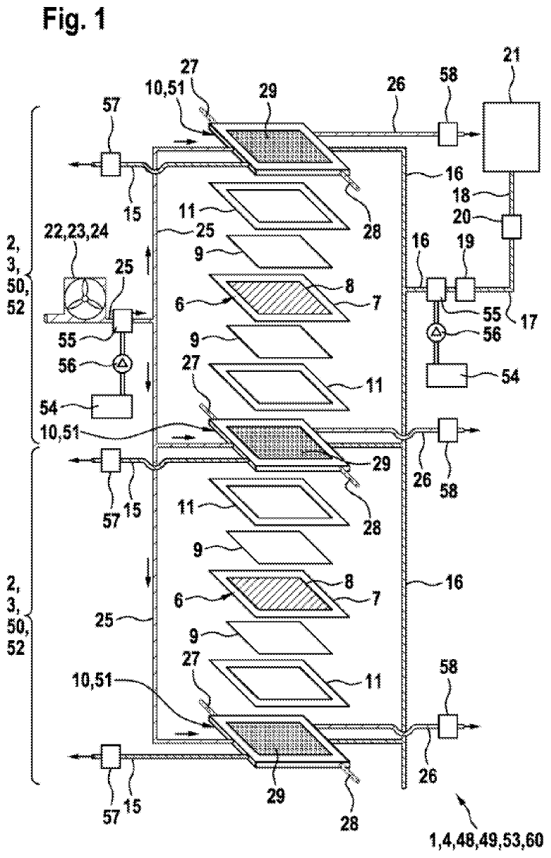

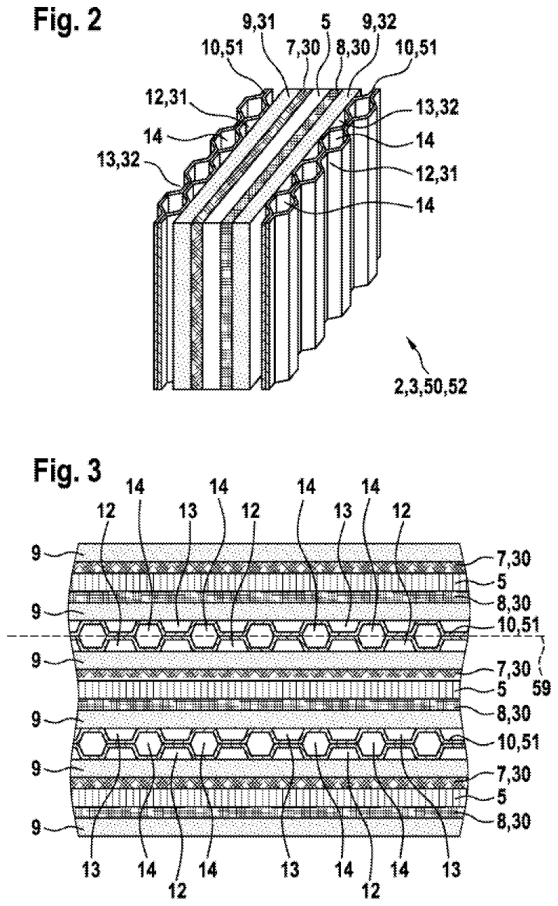

In FIGS. 1 to 3, the basic construction of a fuel cell 2 is shown as a PEM fuel cell 3 (polymer electrolyte fuel cell 3). The principle of fuel cells 2 is that electrical energy or electrical current is generated by means of an electrochemical reaction. Hydrogen H₂ is conducted to an anode 7 as a gaseous fuel, and the anode 7 forms the negative pole. A gaseous oxidant, i.e., air with oxygen, is conducted to a cathode 8, i.e., the oxygen in the air makes available the necessary gaseous oxidant. A reduction (electron uptake) takes place on the cathode 8. The oxidation as electron output is performed at the anode 7.

The redox equations of the electrochemical processes are as follows:

$$Cathode :$$

$${O}_{2} + 4 {H}^{+} + 4 {e}^{-} \text{-->>} 2 {H}_{2} O$$

$$Anode :$$

$$2 {H}_{2} \text{-->>} 4 {H}^{+} + 4 {e}^{-}$$

Summed reaction equation of cathode and anode:

$$2 {H}_{2} + {O}_{2} \text{-->>} 2 {H}_{2} O$$

The difference in the normal potentials of the electrode pairs under standard conditions as reversible fuel cell voltage or neutral voltage of the unloaded fuel cell 2 is 1.23 V. This theoretical voltage of 1.23 V is not achieved in practice. At rest and at small currents, voltages above 1.0 V can be achieved and, in operation at larger currents, voltages between 0.5 V and 1.0 V are achieved. The series connection of multiple fuel cells 2, in particular a fuel cell unit 1 as a fuel cell stack 1 of multiple stacked fuel cells 2, has a higher voltage, which corresponds to the number of fuel cells 2 multiplied by the individual voltage of each fuel cell 2.

The fuel cell 2 also comprises a proton exchange membrane 5 (PEM), which is arranged between the anode 7 and the cathode 8. The anode 7 and cathode 8 are designed in a layer or disc shape. The PEM 5 functions as an electrolyte, catalyst carrier, and separating device for the reaction gases. The PEM 5 also functions as an electrical insulator and prevents an electrical short circuit between the anode 7 and cathode 8. In general, 12 μm to 150 μm thick, proton-conductive films made of perfluorinated and sulfonated polymers are used. The PEM 5 conducts the protons H⁺ and substantially blocks ions other than protons H⁺ so that charge transport can occur due to the permeability of PEM 5 for the protons H⁺. The PEM 5 is substantially impermeable to the reaction gases oxygen O₂ and hydrogen H₂, i.e., it blocks the flow of oxygen O₂ and hydrogen H₂ between a gas chamber 31 at the anode 7 with fuel hydrogen H₂ and the gas chamber 32 at the cathode 8 with air and Oxygen O₂ as oxidizers. The proton conductivity of the PEM 5 increases with increasing temperature and increasing water content.

On the two sides of the PEM 5, each facing the gas chambers 31, 32, the electrodes 7, 8 are located as the anode 7 and cathode 8. A unit consisting of the PEM 5 and the electrodes 7, 8 is referred to as a membrane electrode assembly 6 (MEA). The electrodes 7, 8 are pressed together with the PEM 5. The electrodes 7, 8 are platinum-containing carbon particles that are bonded to PTFE (polytetrafluoroethylene), FEP (fluorinated ethylene-propylene copolymer), PFA (perfluoroalkoxy), PVDF (polyvinylidene fluoride) and/or PVA (polyvinyl alcohol) and are hot-pressed into microporous carbon fiber, glass fiber, or plastic mats. A catalyst layer 30 is normally applied to each of the electrodes 7, 8 on the side facing the gas chambers 31, 32 (not shown). The catalyst layer 30 on the gas chamber 31 with fuel at the anode 7 comprises nanodispersed platinum ruthenium on graphitized soot particles bonded to a binder. The catalyst layer 30 on the gas chamber 32 with an oxidizer on the cathode 8 similarly comprises nanodispersed platinum. Binders include, e.g., Nafion®, a PTFE emulsion, or polyvinyl alcohol.

Deviating from this, the electrodes 7, 8 are composed of an ionomer, e.g. Nafion®, platinum-containing carbon particles, and additives. These electrodes 7, 8 comprising the ionomer are electrically conductive due to the carbon particles and also conduct the protons H′ and also act as a catalyst layer 30 due to the platinum-containing carbon particles. Membrane electrode assemblies 6 with these electrodes 7, 8 comprising the ionomer form membrane electrode assemblies 6 as CCM (catalyst coated membrane).

A gas diffusion layer 9 (GDL) is located on the anode 7 and cathode 8. The gas diffusion layer 9 at the anode 7 evenly distributes the fuel from channels 12 for fuel to the catalyst layer 30 at the anode 7. The gas diffusion layer 9 on the cathode 8 evenly distributes the oxidizer from channels 13 for oxidizer onto the catalyst layer 30 at the cathode 8. The GDL 9 also draws reaction water counter to the direction of flow of the reaction gases, i.e., in a direction from the catalyst layer 30 to the channels 12, 13. Furthermore, the GDL 9 keeps the PEM 5 moist and conducts the power.

The GDL 9 is, e.g., composed of a hydrophobized carbon paper as a carrier and substrate layer and a bonded carbon powder layer as a microporous layer.

A bipolar plate 10 lies atop the GDL 9. The electrically conductive bipolar plate 10 serves as a current collector, for draining water and for conducting the reaction gases as process fluids through the channel structures 29 and/or flow fields 29 and for dissipating the waste heat, which occurs in particular during the exothermic electrochemical reaction at the cathode 8. To dissipate the waste heat, channels 14 are incorporated into the bipolar plate 10 as a channel structure 29 for the passage of a liquid or gaseous coolant as a process fluid. The channel structure 29 on the gas chamber 31 for fuel is formed by channels 12. The channel structure 29 on the gas chamber 32 for oxidizers is formed by channels 13. The materials used for the bipolar plates 10 include metal, conductive plastics and composite materials and/or graphite.

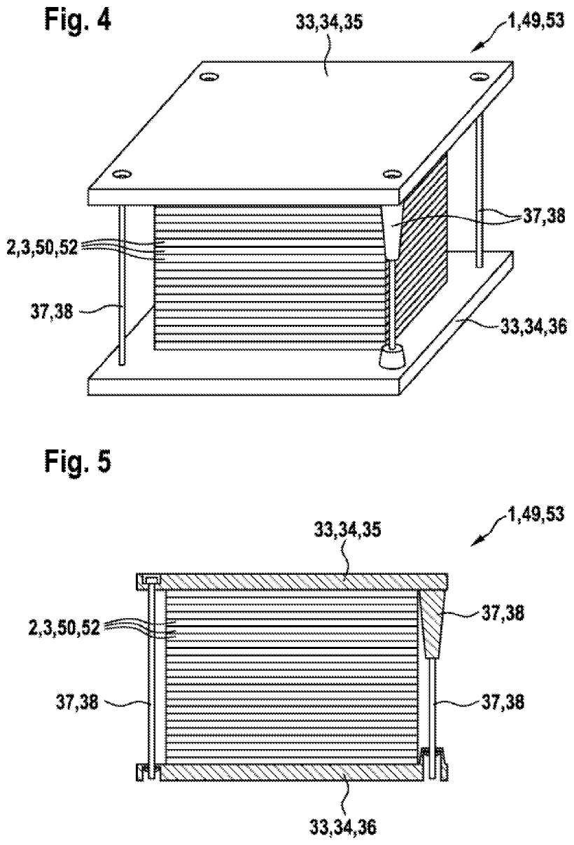

In a fuel cell unit 1 and/or a fuel cell stack 1 and/or a fuel cell stack 1, multiple fuel cells 2 are arranged to be stacked in alignment (FIGS. 4 and 5). FIG. 1 shows an exploded view of two stacked fuel cells 2 arranged in a flush manner. Sealing gaskets 11 seal the gas chambers 31, 32 or channels 12, 13 in a fluidically sealed manner. In a compressed gas reservoir 21 (FIG. 1), hydrogen H₂ is stored as a fuel at a pressure of, e.g., 350 bar to 700 bar. From the compressed gas reservoir 21, the fuel is conducted through a high pressure line 18 to a pressure reducer 20 in order to reduce the pressure of the fuel in a medium pressure line 17 of about 10 bar to 20 bar. From the medium pressure line 17, the fuel is conducted towards an injector 19. At the injector 19, the pressure of the fuel is reduced to an injection pressure of between 1 bar and 3 bar. From the injector 19, the fuel is supplied to a fuel supply line 16 (FIG. 1) and from the supply line 16 to the fuel channels 12 forming the channel structure 29 for fuel. As a result, the fuel passes through the gas chamber 31 for the fuel. The gas chamber 31 for the fuel is formed by the channels 12 and the GDL 9 at the anode 7. After passing through the channels 12, the fuel not consumed in the redox reaction at the anode 7 (and optionally water) are discharged from a controlled humidification means of the anode 7 via a discharge line 15 from the fuel cells 2.

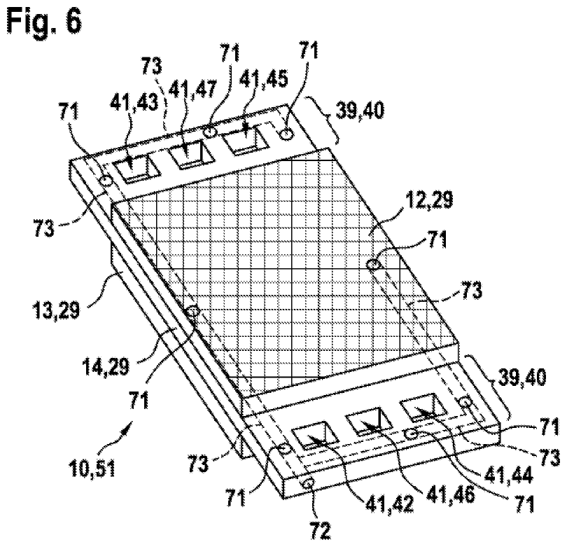

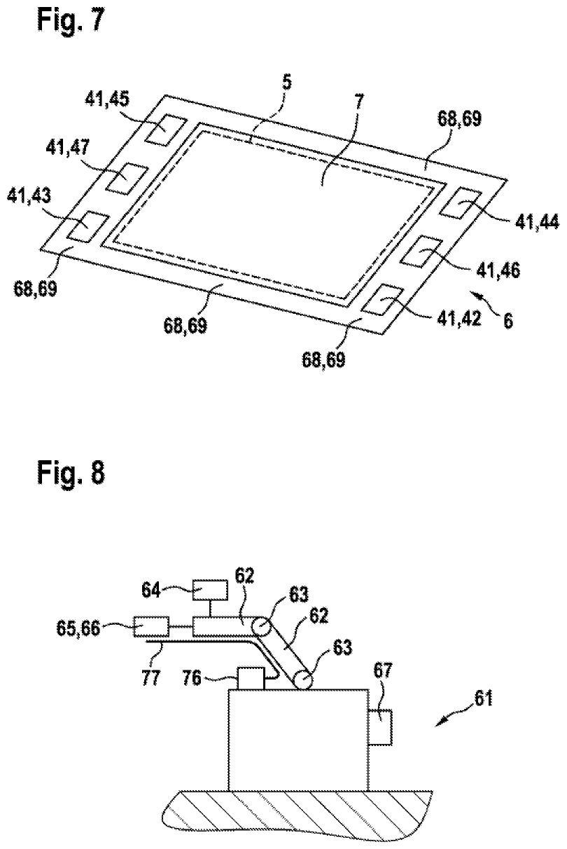

A gas conveying device 22, designed as, e.g., a blower 23 or a compressor 24, conveys air from the surroundings as an oxidizer into an oxidizer supply line 25. From the supply line 25, the air is supplied to the oxidizer channels 13, which form a channel structure 29 on the bipolar plates 10 for oxidizers such that the oxidizer passes through the gas chamber 32 for the oxidizer. The gas chamber 32 for the oxidizer is formed by the channels 13 and the GDL 9 at the cathode 8. After passing through the channels 13 or the gas chamber 32 for the oxidizer 32, the oxidizer not consumed on the cathode 8 and the reaction water resulting on the cathode 8 due to the electrochemical redox reaction are discharged from the fuel cells 2 through a discharge line 26. A supply line 27 is used to supply coolant into the channels 14 for coolant, and a discharge line 28 is used to discharge coolant conducted through the channels 14. The supply and discharge lines 15, 16, 25, 26, 27, 28 are shown as separate lines in FIG. 1 for reasons of simplification. At the end region in the vicinity of the channels 12, 13, 14, fluid openings 41 are formed in the stack as a stack of the fuel cell unit 1 on sealing plates 39 as an extension at the end region 40 of the bipolar plates 10 (FIG. 6) and membrane electrode arrangements 6 (FIG. 7) lying on top of one another. The fuel cells 2 and the components of the fuel cells 2 are disc-shaped and span imaginary planes 59 that are essentially parallel to one another. The flush fluid openings 41 and sealing gaskets (not shown) in a direction perpendicular to the imaginary planes 59 between the fluid openings 41 thereby form a supply channel 42 for oxidizing agent, a discharge channel 43 for oxidizing agent, a supply channel 44 for fuel, a discharge channel 45 for fuel, a supply channel 46 for coolant and a discharge channel 47 for coolant. The supply and discharge lines 15, 16, 25, 26, 27, 28 outside the stack of the fuel cell unit 1 are designed as process fluid lines. The supply and discharge lines 15, 16, 25, 26, 27, 28 outside the stack of the fuel cell unit 1 open into the supply and discharge channels 42, 43, 44, 45, 46, 47 inside the stack of the fuel cell unit 1. The fuel cell stack 1, together with the compressed gas reservoir 21 and the gas conveying device 22, form a fuel cell system 4.

In the fuel cell unit 1, the fuel cells 2 are arranged between two clamping elements 33 as clamping plates 34. A first clamping plate 35 rests on the first fuel cell 2 and a second clamping plate 36 rests on the last fuel cell 2. The fuel cell unit 1 comprises approximately 200 to 400 fuel cells 2, not all of which are shown in FIGS. 4 and 5 for graphic reasons. The clamping elements 33 apply a compressive force to the fuel cells 2, i.e., the first clamping plate 35 rests with a compressive force on the first fuel cell 2 and the second clamping plate 36 rests with a compressive force on the last fuel cell 2. The fuel cell stack 2 is thereby braced to ensure sealing for the fuel, the oxidizing agent and the coolant, in particular due to the elastic sealing gaskets 11, and also to keep the electrical contact resistance within the fuel cell stack 1 as low as possible. To tension the fuel cells 2 comprising the tensioning elements 33, four connecting devices 37 are formed as bolts 38 on the fuel cell unit 1, which are subjected to tensile stress. The four bolts 38 are connected to the clamping plates 34.

FIG. 6 shows the bipolar plate 10 of the fuel cell 2. The bipolar plate 10 comprises the channels 12, 13 and 14 as three separate channel structures 29. The channels 12, 13 and 14 are not shown separately in FIG. 6, but merely simplified as a layer of a channel structure 29. The fluid openings 41 on the sealing plates 39 of the bipolar plates 10 (FIG. 6) and membrane electrode assemblies 6 (FIG. 7) are stacked in alignment within the fuel cell unit 1 so that supply and discharge channels 42, 43, 44, 45, 46, 47 are formed. Sealing gaskets not shown are arranged between the sealing plates 39 for fluidically sealed closure of the supply and discharge channels 42, 43, 44, 45, 46, 47 formed by the fluid openings 41.

Since the bipolar plate 10 also separates the gas chamber 31 for fuel from the gas chamber 32 for oxidizing agent in a fluidically sealed manner and also seals the channel 14 for coolant in a fluidically sealed manner, the term “separator plate” 51 can also be selected for the bipolar plate 10 for the fluidically sealed separation or separation of process fluids. The term “bipolar plate” 10 thereby also includes the term separator plate 51 and vice versa. The channels 12 for fuel, the channels 13 for oxidizing agent, and the channels 14 for coolant of the fuel cell 2 are also formed on the electrochemical cell 52, but with a different function.

The fuel cell unit 1 can also be used and operated as an electrolysis cell unit 49, i.e., it forms a reversible fuel cell unit 1. In the following, several features are described which enable the fuel cell unit 1 to be operated as an electrolysis cell unit 49. A liquid electrolyte, i.e., highly diluted sulphuric acid at a concentration of approximately c (H₂SO₄)=1 mol/l, is used for electrolysis. A sufficient concentration of oxonium ions H₃O⁺ in the liquid electrolyte is necessary for electrolysis.

The following redox reactions take place during electrolysis:

$$Cathode :$$

$$4 {H}_{3} {O}^{+} + 4 {e}^{-} -- >> 2 {H}_{2} + 4 {H}_{2} O$$

$$Anode :$$

$$6 {H}_{2} O -- >> {O}_{2} + 4 {H}_{3} {O}^{+} + 4 {e}^{-}$$

Summed reaction equation of cathode and anode:

$$2 {H}_{2} O \text{-->>} 2 {H}_{2} + {O}_{2}$$

The polarity of the electrodes 7, 8 is reversed using electrolysis during operation as an electrolysis cell unit 49 (not shown) as during operation as a fuel cell unit 1, so that hydrogen H₂ is formed as a second substance at the cathodes in the channels 12 for fuel, through which the liquid electrolyte is passed, and the hydrogen H₂ is absorbed by the liquid electrolyte and transported in solution. Similarly, the liquid electrolyte is fed through the channels 13 for oxidizing agents and oxygen O₂ is formed as the first substance at the anodes in or at channels 13 for oxidizing agents. The fuel cells 2 of the fuel cell unit 1 function as electrolysis cells 50 during operation as electrolysis cell unit 49. The fuel cells 2 and electrolysis cells 50 therefore form electrochemical cells 52. The oxygen O₂ formed is absorbed by the liquid electrolyte and transported in solution. The liquid electrolyte is stored in a storage reservoir 54. For reasons of simplification, FIG. 1 shows two storage reservoirs 54 of the fuel cell system 4, which also functions as an electrolysis cell system 48. The 3-way valve 55 on the supply line 16 for fuel is switched over during operation as an electrolysis cell unit 49, so that the liquid electrolyte is fed into the supply line 16 for fuel by a pump 56 from the storage reservoir 54 rather than fuel from the compressed gas reservoir 21. A 3-way valve 55 on the supply line 25 for oxidizing agent is switched over during operation as electrolysis cell unit 49, so that the liquid electrolyte is fed into the supply line 25 for oxidizing agent by the pump 56 from the storage reservoir 54 rather than oxidizing agent as air from the gas conveying device 22. The fuel cell unit 1, which also functions as an electrolysis cell unit 49, has optional modifications to the electrodes 7, 8 and the gas diffusion layer 9 compared to a fuel cell unit 1 that can only be operated as a fuel cell unit 1: for example, the gas diffusion layer 9 is not absorbent, so the liquid electrolyte easily runs off completely, or the gas diffusion layer 9 is not formed, or the gas diffusion layer 9 is a structure on the bipolar plate 10. The electrolysis cell unit 49 comprising the storage reservoir 54, the pump 56, and the separators 57, 58 and preferably the 3-way valve 55 forms an electrochemical cell system 60.

A separator 57 for hydrogen is arranged on the discharge line 15 for fuel. The separator 57 separates the hydrogen from the electrolyte with hydrogen and the separated hydrogen is fed into the compressed gas reservoir 21 by a compressor (not shown). The electrolyte drained from the separator 57 for hydrogen is then fed back to the storage reservoir 54 for the electrolyte via a line. A separator 58 for oxygen is arranged on the discharge line 26 for fuel. The separator 58 separates the oxygen from the electrolyte with oxygen and the separated oxygen is fed into a compressed gas reservoir for oxygen (not shown) using a compressor (not shown). The oxygen in the compressed gas reservoir for oxygen, which is not shown, can optionally be used for the operation of the fuel cell unit 1 by sliding the oxygen into the supply line 25 for oxidizing agent with a line (not shown) during operation as a fuel cell unit 1. The electrolyte drained from the separator 58 for oxygen is then fed back to the storage reservoir 54 for the electrolyte via a line. The channels 12, 13 and the discharge and supply lines 15, 16, 25, 26 are designed such that after use as an electrolysis cell unit 49 and the pump 56 is switched off, the liquid electrolyte runs back completely into the storage reservoir 54 due to gravity. Optionally, after use as an electrolysis cell unit 49 and before use as a fuel cell unit 1, an inert gas is passed through the channels 12, 13 and the discharge and supply lines 15, 16, 25, 26 to completely remove the liquid electrolyte before the gaseous fuel and oxidizing agent are passed through. The fuel cells 2 and the electrolysis cells 2 therefore form electrochemical cells 52. The fuel cell unit 1 and the electrolysis cell unit 49 thereby form an electrochemical cell unit 53. The channels 12 for fuel and the channels for oxidizing agent thereby form channels 12, 13 for the passage of the liquid electrolyte during operation as an electrolysis cell unit 49 and this applies in a similar manner to the supply and discharge lines 15, 16, 25, 26. For process-related reasons, an electrolysis cell unit 49 does not normally require channels 14 for the passage of coolant. In an electrochemical cell unit 49, the channels 12 for fuel also form channels 12 for passing fuel and/or electrolytes and the channels 13 for oxidizing agents also form channels 13 for passing fuel and/or electrolytes.

In another exemplary embodiment, (not shown) the fuel cell unit 1 is designed as an alkaline fuel cell unit 1. Potassium hydroxide solution is used as a mobile electrolyte. The fuel cells 2 are arranged in a stack. A monopolar cell structure or a bipolar cell structure can be formed. The potassium hydroxide solution circulates between an anode and cathode and removes reaction water, heat and impurities (carbonates, dissolved gases). The fuel cell unit 1 can also be operated as a reversible fuel cell unit 1, i.e., as an electrolysis cell unit 49.

FIG. 8 shows a robot 61 for producing the electrochemical cell unit 53. The robot 61 comprises robot arms 62 and robot joints 63. A process unit 65 in the form of a mechanical gripper 66 and/or a suction pad 66 and a camera 64 are attached to an end section of a last robot arm 62. The gripper 66 is attached to the last robot arm 62 using a motorized movable ball joint (not shown). A vacuum pump 76 and a suction tube 77 or suction line 77 are also attached to the robot 61. The suction tube 77 is also attached to the robot arms 62 and is bendable. Due to the bendable properties of the suction tube 77, the suction tube 77 can also perform these movements during movements between the robot arms 62 at the robot joints 63. The end section of the suction tube 77 is arranged in the vicinity of the gripper 66 and the end section of the suction tube 77 can be moved in any direction using an actuator (not shown). The vacuum pump 76 generates a reduced pressure compared to an ambient pressure and, by means of the suction tube 77, this reduced pressure also occurs at the end of the suction tube 77 near the gripper 66. A computer 67 comprising a processor and a data memory controls the robot 61. Position data regarding the intended geometric arrangement of the bipolar plates 10, and/or gas diffusion layers 9, and/or proton exchange membranes 5, and/or membrane electrode arrangements 6, and/or regarding the relative position of the robot 61 to the stack of the electrochemical cell unit 53 are stored in the data memory. The camera 64 optically captures images of the bipolar plates 10 and/or gas diffusion layers 9 and/or proton exchange membranes 5 and/or membrane electrode arrays 6, and image processing software in the computer 67 is used to capture the actual relative position of the bipolar plates 10 and/or gas diffusion layers 9 and/or proton exchange membranes 5 and/or membrane electrode arrays 6 to the robot 48. The movement of the robot 61 is therefore controlled as a function of the intended position data stored in the data memory and/or the data determined by the image processing software for the actual position of the bipolar plates 10 and/or gas diffusion layers 9 and/or proton exchange membranes 5 and/or membrane electrode arrangements 6 relative to the robot 48. The stored position data can therefore be corrected using the data determined by the image processing software for the actual position of the bipolar plates 10 and/or gas diffusion layers 9 and/or proton exchange membranes 5 and/or membrane electrode arrangements 6 relative to the robot 61 so that, in an advantageous manner, deviations in the geometric arrangement of the bipolar plates 10 and/or gas diffusion layers 9 and/or proton exchange membranes 5 and/or membrane electrode arrangements 6, e.g. due to manufacturing inaccuracies, have no effect on the production process. The robot 61 further comprises a second mechanical gripper 66 (not shown).

For the production of an electrochemical cell unit 53, the layered components 5, 6, 7, 8, 9, 10, 30, 51 of electrochemical cells 52 are first made available. The layered components 5, 6, 7, 8, 9, 10, 30, 51 are, e.g., a proton exchange membrane 5, an anode 7, a cathode 8, a gas diffusion layer 9, and a bipolar plate 10 in a fuel cell unit 1. The anode 7, the cathode 8, and the proton exchange membrane 5 form a membrane electrode arrangement 6 comprising a subgasket 69 as a sealing layer 68 in which the anode 7 and the cathode 8 are additionally provided with a catalyst material as a CCM (catalyst coated membrane) so that the anode 7 and the cathode 8 additionally form a catalyst layer 30. The layered components 5, 6, 7, 8, 9, 10, 30, 51 of the fuel cells 2 are stacked to form a stack, e.g. as shown in FIGS. 3 and 4.

The bipolar plates 10 are made available such that they comprise suction openings 71 (FIG. 6). The suction openings 71 are connected to each other in a fluidically conducting and fluidically sealed manner by air channels 73 integrated into the bipolar plate 10. Apart from the suction openings 71, the air channels 73 have only one connection to the surroundings, i.e., at a connection opening 72. The connection opening 72 serves to place one end of the suction tube 77 on the robot 61 on the bipolar plate 10 in the vicinity of the connection opening 72, so that a fluidically sealed and gas-sealed connection exists between the air channel 73 in the bipolar plate 10 and the suction tube 77 on the robot 61. A rubber ring is formed at the end of the flexible suction tube 77 for this purpose. This allows the vacuum pump 76 to bring by suction air from the surroundings into the suction openings 71 to generate a reduced pressure at the suction openings 71.

Deviating from this, the suction openings 71 can also be formed only as through-holes on the bipolar plates 10, which connect an upper side 74 of the bipolar plates 10 directly to a lower side 75 of the bipolar plates 10. Regarding these bipolar plates 10 comprising the suction openings 71 as through-holes, it is necessary for multiple suction tubes 77 to be placed on a support frame as grippers 66 on the through-holes on the underside 75 for the suction of air through the through-holes, so that the reduced pressure can be generated at the through-holes on the upper side 74 as the suction openings 71 (not shown).

FIG. 7 shows a membrane electrode arrangement 6 in a perspective view. The anode 7 is located on the upper side of the proton exchange membrane 5 (shown as a dotted line in FIG. 7) and the cathode 8 (not shown in FIG. 7) is located on the lower side. A catalyst material is integrated into the anode 7 and the cathode 8, e.g. particulate platinum, so that the anode 7 and the cathode 8 also form the catalyst layer 30. The proton exchange membrane 5 thereby forms a CCM (catalyst coated membrane). The layered proton exchange membrane 5 comprising the layered anode 7 and the layered cathode 8 are framed and enclosed by a sealing layer 68 as a subgasket 69, i.e. an end region of the proton exchange membrane 5 comprising the anode 7 and the cathode 8 is arranged and fixed between the subgasket 69. The fluid openings 41 are formed at one end region and at an extension of the subgasket 68, which are flush with the fluid openings 41 on the bipolar plate 10 when arranged in the stack of the fuel cell unit 1.

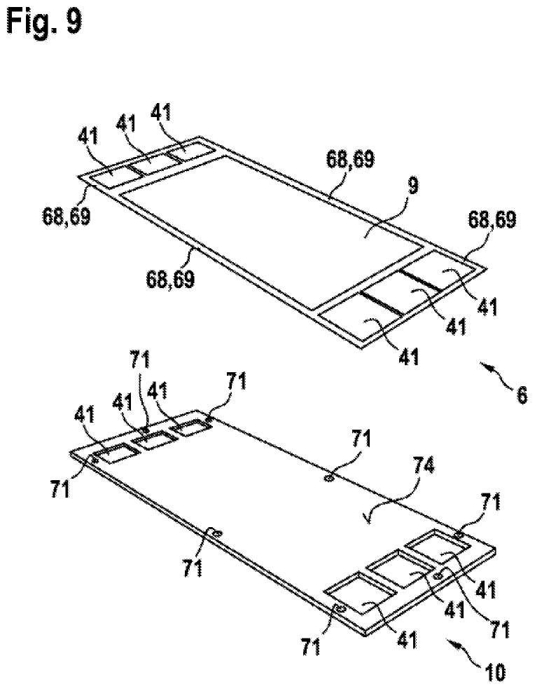

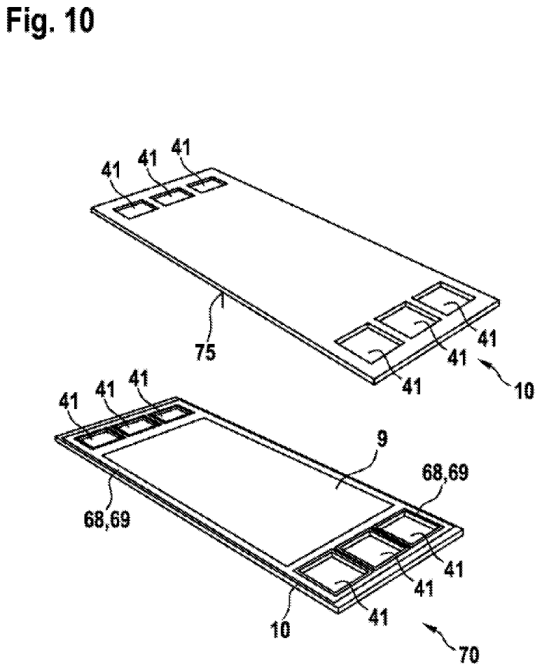

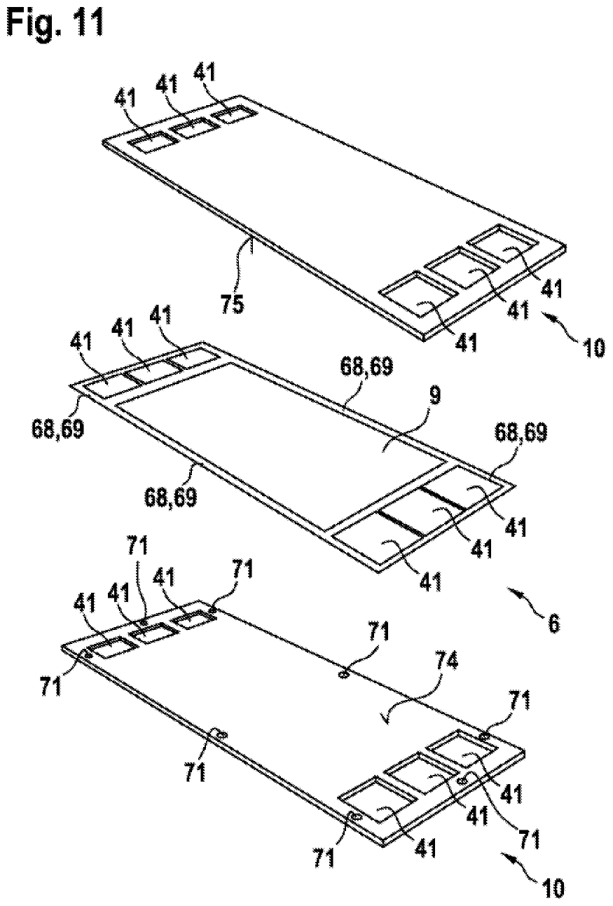

FIGS. 9 and 10 show a first exemplary embodiment of a method for producing the fuel cell unit 1 as the electrochemical cell unit 53. A gas diffusion layer 9 is also arranged on the top and bottom sides of the membrane electrode arrangement 6 as CCM shown in FIG. 7. The membrane electrode assembly 6 comprising the two gas diffusion layers 9 is placed on an upper surface 74 of the bipolar plate 10 so that the membrane electrode assembly 6 comprising the two gas diffusion layers 9 and the bipolar plate 10 form an intermediate assembly unit 70. This intermediate assembly unit 70 is then moved using the grippers 66 of the robot 61 to the partially produced stack of the fuel cell unit 1. Even before the membrane electrode arrangement 6 comprising gas diffusion layers 9 is applied, the end of the suction tube 77 is brought into fluidically sealed connection with the connection opening 72 on the bipolar plate 10 and the vacuum pump 76 is also activated, so that air from the surroundings is sucked into the suction openings 71 by means of the vacuum pump 76. During this process of sucking in the air through the suction openings 71 using the vacuum pump 76, the membrane electrode arrangement 6 comprising the two gas diffusion layers 9 is placed precisely on the upper side 74 of the bipolar plate 10 using another robot 61. After placing the membrane electrode arrangement 6 comprising the two gas diffusion layers 9 on the upper side 74 of the bipolar plate 10, the subgasket 69 of the membrane electrode arrangement 6 covers the suction openings 71, so that the subgasket 69 is brought by suction by means of reduced pressure due to the reduced pressure at the suction openings 71 and fixed to the bipolar plate 10.

Subsequently, in a first variant shown in FIGS. 9 and 10, this intermediate assembly unit 70 is moved by a gripper 66 of the robot 61 at a high speed to the partially stacked stack of the fuel cell unit 1. Due to the fixation of the subgasket 69 of the membrane electrode arrangement 6, no relative movement occurs between the membrane electrode arrangement 6 and the bipolar plate 10 despite the force applied to the membrane electrode arrangement 6 by the air during the movement due to the fixation of the membrane electrode arrangement 6 by means of the reduced pressure in the suction openings 71 at the subgasket 69.

In a second variant shown in FIGS. 9 and 10, a second bipolar plate 10 (FIG. 10 top) is placed on the intermediate assembly unit 70, as shown in FIG. 10, before the intermediate assembly unit 70 is placed on it, and this intermediate assembly unit 70 (not shown), which is formed by the two bipolar plates 10 comprising the membrane electrode arrangement 6 arranged between them and the two gas diffusion layers 9 is moved to the partially stacked stack of the fuel cell unit 10 using the robot 61 by means of grippers 66. After placement of the membrane electrode arrangement 6 comprising the two gas diffusion layers 9 has been positioned in a manner similar to the first variant, the membrane electrode arrangement 6 is fixed to the bipolar plate 10 by means of reduced pressure at the suction openings 71 so that, after the membrane electrode arrangement 6 comprising the gas diffusion layers 9 has been placed on the upper side 74 of the bipolar plate 10 and before the second bipolar plate 10 has been placed, no relative movement occurs between the membrane electrode arrangement 6 and the lower first bipolar plate 10 due to the fixing by means of reduced pressure. For example, the membrane electrode arrangement 6 comprising the two gas diffusion layers 9 is placed on the lower first bipolar plate 10 at a first assembly station (not shown) and then a movement of the intermediate assembly unit 70 comprising the first lower bipolar plate 10 comprising the membrane electrode arrangement 6 and the two gas diffusion layers 9 to a second assembly station (not shown) is necessary. At the second assembly station, the second upper bipolar plate 10 is placed on the intermediate assembly unit 70. Both in the first variant and in the second variant shown in FIGS. 9 and 10, the membrane electrode arrangement 6 and the two gas diffusion layers 9 can be placed separately on the upper side 74 of the bipolar plate 10 by successively placing the gas diffusion layer 9, the membrane electrode arrangement 6, and the further gas diffusion layer 9 on the upper side 74 of the bipolar plate 10. Deviating from this, both in the first variant and in the second variant shown in FIGS. 9 and 10, the two gas diffusion layers 9 can first be attached to the membrane electrode arrangement 6, preferably in a bonded manner before the two gas diffusion layers 9 and the membrane electrode arrangement 6, which have already been joined together, are placed together on the upper side 74 of the bipolar plate 10.

FIG. 11 shows a second exemplary embodiment of the method for producing the fuel cell unit 1. The membrane electrode arrangement 6 comprising the two gas diffusion layers 9 is placed on an underside 75 of an upper, second bipolar plate 10 by means of grippers 66 of the robot 61 and, due to the reduced pressure in the suction openings 71, the subgasket 69 of the membrane electrode arrangements 6 is brought by suction by the suction openings 71, thereby temporarily fixing the membrane electrode arrangement 6 to the upper, second bipolar plate 10 due to the reduced pressure. During the temporary fixing of the membrane electrode arrangement 6 to the underside 75 of the upper, second bipolar plate 10, the second, upper bipolar plate 10 is placed on the first bipolar plate 10 shown in FIG. 11 below, so that the two gas diffusion layers 9 and the membrane electrode arrangement 6 are thereby placed on the upper side 74 of the first, lower bipolar plate 10 and the membrane electrode arrangement 6 comprising the two gas diffusion layers 9 is thereby arranged between the two bipolar plates 10. Due to the temporary fixation of the membrane electrode arrangement 6 comprising gas diffusion layers 9 on the underside 74 of the second upper bipolar plate 10 by means of reduced pressure, no relative movement occurs between the membrane electrode arrangement 6 and the two gas diffusion layers 9 on the one hand and the second upper bipolar plate 10 on the other hand during the movement of the second bipolar plate 10 in the direction of the first bipolar plate 10. In the second exemplary embodiment, before the membrane electrode arrangement 6 is temporarily fixed to the gas diffusion layers 9 on the underside 75 of the bipolar plate 10, the two gas diffusion layers 9 are already bonded to the membrane electrode arrangement 6 by means of reduced pressure.

The processes described above can also be used in a similar manner to produce an electrochemical cell unit 49.

Overall, the method according to the invention for producing the electrochemical cell unit 53 and the electrochemical cell unit 53 according to the invention have significant advantages. Layered components 5, 6, 7, 8, 9, 10, 30, 51 of the fuel cell unit 1, e.g. membrane electrode arrangements 6 and/or gas diffusion layers 9, can be temporarily fixed in a simple manner by means of the reduced pressure at the suction openings 71 of the bipolar plates 10. The production of the fuel cell unit 1 using the robot 61 in an industrial method with large quantities can as a result be significantly optimized and improved. Any intermediate assembly units 70, each comprising at least one bipolar plate 10 and comprising at least one layered component 5, 6, 7, 8, 9, 10, 30, 51, can be moved in space using the robot 61 at a high speed due to the temporary fixation by means of the reduced pressure and can also be subjected to high accelerations and/or decelerations. Due to the temporary fixation, no relative movement occurs between the bipolar plate 10 and the at least one layered component 5, 6, 7, 8, 9, 10, 30, 51 despite the high speed in space and the large accelerations and/or decelerations that occur. The layered components 5, 6, 7, 8, 9, 10, 30, 51 must be positioned on the bipolar plate 10 at an accuracy of a few 1/10 mm. After the layered components 5, 6, 7, 8, 9, 10, 30, 51 have been placed on the bipolar plates 10, the suction forces at the suction openings 71 ensure that the relative movement between the layered components 5, 6, 7, 8, 9, 10, 30, 51 and the bipolar plates 10 is excluded in a direction parallel to the imaginary planes 59. As a result, intermediate assembly units 70 are advantageously able to be moved in space at high speed by the robot 61 with the at least one bipolar plate 10 and at least one layered component 5, 6, 7, 8, 9, 10, 30, 51 without the resulting air movement and negative and positive acceleration triggering a relative movement between the bipolar plate 10 and at least one layered component 5, 6, 7, 8, 9, 10, 30, 51. Readjustment of the layered components 5, 6, 7, 8, 9, 10, 30, 51 already placed on the bipolar plate 10 is therefore advantageously no longer necessary. Overall, this enables safe, reliable, fast, cost-effective and precise production of electrochemical cell units 53.

1. A method for producing an electrochemical cell unit (53) for converting electrochemical energy into electrical energy as a fuel cell unit (1) and/or for converting electrical energy into electrochemical energy as an electrolysis cell unit (49) comprising stacked electrochemical cells (52), the method comprising the following steps:
making available layered components (5, 6, 7, 8, 9, 10, 30, 51) of the electrochemical cells (52), the layered components including proton exchange membranes (5), anodes (7), cathodes (8), membrane electrode assemblies (6), gas diffusion layers (9) and bipolar plates (10),
stacking the layered components (5, 6, 7, 8, 9, 10, 30, 51) to form electrochemical cells (52) and to form a stack of the electrochemical cell unit (53),
wherein
the bipolar plates (10) are made available such that at least one suction opening (71) is formed in each of the bipolar plates (10) and components (5, 6, 7, 8, 9, 10, 30, 51) of the electrochemical cells (52) are brought by suction by a reduced pressure in the suction openings (71) during production such that the components (5, 6, 7, 8, 9, 10, 30, 51) brought to the suction openings (71) are fixed to the bipolar plates (10) by the reduced pressure.

2. The method according to claim 1,
wherein
the components brought by suction (5, 6, 7, 8, 9, 10, 30, 51) are placed on the bipolar plates (10), and the reduced pressure is generated in the suction openings (71) before, and/or during, and/or after placement.

3. The method according to claim 1,
wherein
the reduced pressure is generated by at least one vacuum pump (76).

4. The method according to claim 1,
wherein
a plurality of suction openings (71) are formed in each bipolar plate (10) and the suction openings (71) are connected to one another in an air-conducting manner by an air channel (73) integrated into each bipolar plate (10).

5. The method according to claim 4,
wherein
the air channel (73) opens into one connecting opening (72) on an outer side of the respective bipolar plate (10) so that the reduced pressure is generated at the suction openings (71) of the respective bipolar plate (10), by a reduced pressure at the one connecting opening (72).

6. The method according to claim 1,
wherein
components (5, 6, 7, 8, 9, 10, 30, 51) as membrane electrode assemblies (6) of the electrochemical cells (52) are brought by suction during production by a reduced pressure in the suction openings (71).

7. The method according to claim 6,
wherein,
after the membrane electrode arrangements (6) have been placed on the bipolar plates (10), the suction openings (71) are arranged on subgaskets (69) of the membrane electrode arrangements (6) so that the subgaskets (69) of the membrane electrode arrangements (6) are brought by suction by the reduced pressure in the suction openings (71).

8. The method according to claim 6,
wherein
gas diffusion layers (9) are arranged between the bipolar plates (10) and the membrane electrode arrangements (6).

9. The method according to claim 6,
wherein,
during the placement of the membrane electrode arrangements (6) on the bipolar plates (10), the bipolar plates (10) are oriented substantially horizontally, and the membrane electrode arrangements (10) are placed on upper sides (74) of first bipolar plates (10) and brought by suction by the reduced pressure in the suction openings (71), and/or the membrane electrode arrangements (6) are placed on undersides (75) of second bipolar plates (10) and brought by suction by the reduced pressure in the suction openings (71).

10. The method according to claim 1,
wherein
at least one bipolar plate (10) forms an intermediate assembly unit (70) having at least one component brought by suction (5, 6, 7, 8, 9, 10, 30, 51).

11. The method according to claim 10,
wherein
the intermediate assembly units (70) are produced outside an already partially stacked stack of stacked electrochemical cells (52), and then the intermediate assembly units (70) are placed on the already partially stacked stack of stacked electrochemical cells (52).

12. The method according to claim 10,
wherein
the intermediate assembly units (70) are moved by a robot (61) to the already partially stacked stack comprising stacked electrochemical cells (52) and placed on the already partially stacked stack.

13. The method according to claim 10,
wherein
the components (5, 6, 7, 8, 9, 10, 30, 51) and/or intermediate assembly units (70) are moved by mechanical grippers (66) and/or suction pads (66) on at least one robot (61) using the at least one robot (61).

14. The method according to claim 12,
wherein,
during the movement of the intermediate assembly units (70), connecting openings (72) of the bipolar plates (10) are connected in a fluidically conducting manner to a suction tube (77) on the robot (61) so that the reduced pressure in the suction openings (71) of the bipolar plates (10) is generated by a reduced pressure in the suction tube (77).

15. An electrochemical cell unit (53) for converting electrochemical energy into electrical energy as a fuel cell unit (2) and/or for converting electrical energy into electrochemical energy as an electrolysis cell unit (49), comprising:
electrochemical cells (52) arranged in a stacked manner, with the electrochemical cells (52) each comprising layered components (5, 6, 7, 8, 9, 10, 51) arranged in a stacked manner, and
the components (5, 6, 7, 8, 9, 10, 51) of the electrochemical cells (52) including proton exchange membranes (5), anodes (7), cathodes (8), membrane electrode arrangements (6), gas diffusion layers (9) and bipolar plates (10, 51),
wherein
the electrochemical cell unit (53) is manufactured by a method according to claim 1
and/or suction openings (71) are formed in the bipolar plates (10, 51) for a suction of components (5, 6, 7, 8, 9, 10, 51) by a reduced pressure during production.
